(19) United States
(12) Patent Application Publication
(10) Pub. No.: US 2003/0153359 A1
(43) Pub. Date: Aug. 14, 2003

(54) Architecture of a base station of a radio communications system

(76) Inventor: Helmut Kling, Elchingen (DE)

Correspondence Address: STAAS & HALSEY LLP, 700 11TH STREET, NW, SUITE 500, WASHINGTON, DC, 20001, US

(21) Appl. No.: 10/182,674

(22) PCT Filed: Jan. 17, 2001
(86) PCT No.: PCT/DE01/00186

(30) Foreign Application Priority Data
Jan. 31, 2000 (DE) 100 04 107.8

(51) Int. Cl. H04B 1/38

(52) U.S. Cl. 455/561; 455/550

(57) ABSTRACT

A base configuration of a micro-base transceiver station (MicroBTS) has a minimum volume and at least one add-on module that is connected to the base configuration. The modular construction according to a building-block principle enables the minimal base configuration of a micro-base station to be expanded in a versatile manner by adding add-on modules at any time to enlarge the base station by imparting additional technical features.

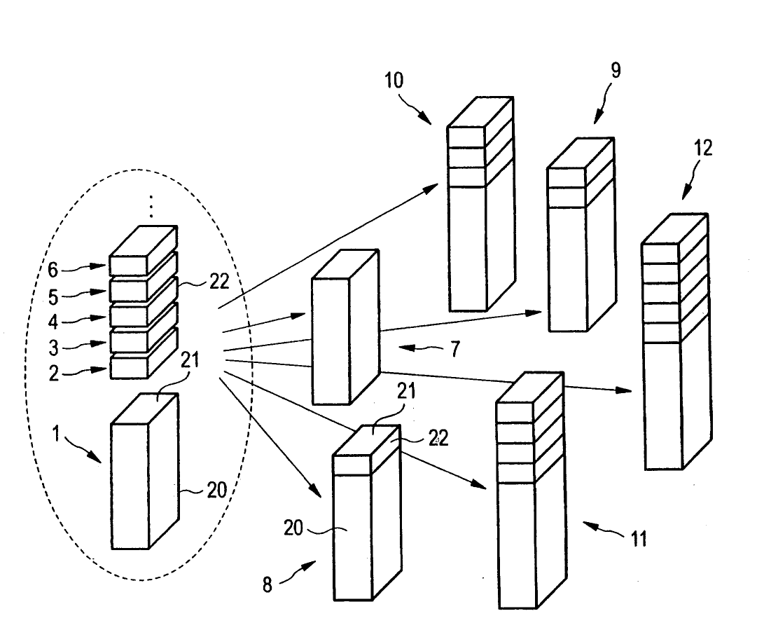

The invention relates to the architecture of a base station of a radio communication system, particularly of a mobile communications system as used, for example, in a mobile radio system according to the GSM standard.

Mobile radio communications systems are based on dividing a total area to be covered into radio cells, each radio cell being supplied by a base station, abbreviated to BTS (base transceiver station), i.e. the base station supplies and administers the mobile stations located within its radio cell. Idealized, the radio cells have a hexagonal shape and overlap in order to ensure a handover of a mobile station into another radio cell of an adjacent base station. In general, a base station comprises transmitting and receiving systems including the antennas and signal processing which is specific to the radio interface. It represents the counterpart to the mobile station and establishes the data exchange with downstream network elements right to the switching office.

Depending on application, for example depending on the size of the radio cell to be covered or the number of carrier frequencies supported, a distinction is made between macro base stations—macroBTS (macro base transceiver station)—and micro base stations—microBTS (micro base transceiver station).

These two forms of a base station have to meet the requirements of different specifications, a fact which is reflected by, among other things, their outer appearance.

Some important differences between a micro base station and a macro base station will be summarized here.

A macro base station handles a large traffic volume in a large radio cell.

Typical ranges of a macro base station are 30 to 50 km. As a result, it is designed for high output powers and must meet all conceivable technical requirements for a base station.

Typical output powers of a macro base station are, for example, up to 50 watts.

To be able to handle larger traffic volumes, it has typically 6 to 24 transceivers.

It typically has a hybrid combiner by means of which the individual carrier frequencies are combined and are applied to an antenna as an aggregate signal, and a number of supervisory functions, so-called site alarms, which monitor subfunctions of the macro base station for disturbances. The macro base station can be linked to the landline network with the aid of different devices.

Due to its design, the electronics, cooling, ventilation and filtering required for it become very extensive and expensive. A macro base station typically requires a volume of at least a few hundred liters.

A macro base station is used for special situations such as, for example, for covering relatively small radio cells for which the use of a macro base station would be too complex and too expensive. Or it is used, for example, if only a limited volume of space is available for utilization.

In this connection, the coverage of small radio cells is becoming more and more important, for example indoor coverage of airports, congress centers and hotels. Using micro base stations also reduces locally limited supply problems of radio subscribers which are due to environment and terrain.

A micro base station only contains the equipment absolutely necessary for its special use.

Thus, the individual carrier frequencies are typically not combined via a hybrid combiner but individually applied to different antennas. The supervisory functions, the so-called site alarms, are typically omitted. Furthermore, they can typically only be linked to the landline network to a restricted extent with the aid of various devices.

It has typically one to four transceivers TRX. Its relatively small output power is typically one watt to five watts, which is sufficient for covering small radio cells. As a result, it has a typical range of a few hundred meters up to a few kilometers.

As a result, a micro base station can be implemented with a minimum volume of typically less than one hundred liters. A very inexpensive implementation is possible.

In the design of a microBTS, a tradeoff between the contradictory requirements for minimum volume, on the one hand, and, on the other hand, the desire for the implementation of as many technical features as possible, corresponding to a macroBTS, is needed. Looked at economically, however, any restriction of the technical capabilities or increase in the volume of a microBTS leads to a restriction of its prospects in the market.

The invention is, therefore, based on the object of creating a microBTS which represents an optimum comprise between volume and technical features.

The object is achieved by the features of claim 1. Preferred embodiments of the invention form the subject matter of the subclaims.

A base station, according to the invention, of a mobile radio communications system, which has electronic assemblies, is constructed modularly in accordance with a building block principle and has a basic configuration of a microBTS with minimum volume and at least one add-on module which is connected to the basic configuration. This basic configuration, therefore, represents a base station having correspondingly restricted technical capabilities such as, for example, only one carrier unit, but can be operated as base station.

The second and any other add-on module is preferably connected to the preceding add-on module to form a base station having the desired technical characteristics.

The electronic assemblies of the basic configuration and of the at least one add-on module are usually arranged on a carrier or in a corresponding electric chassis, called rack hereinafter, which effects the power supply and the data transmission between the assemblies. The carriers or racks, respectively, are designed in such a manner that they can be connected to a total carrier or total rack, respectively, by corresponding construction. For this purpose, connecting elements of a mechanical and electrical nature are provided in a preferred embodiment, which connect the carriers or racks, respectively, to one another, in a fixed or detachable manner.

Examples of such connecting elements are suitable plug-in connectors.

In a preferred embodiment, both the basic configuration and the at least one add-on module each have a housing with minimum volume, the first add-on module being arranged at the basic configuration in such a manner that the two housings form a single total housing in a positively locked manner. The second and any further add-on module is correspondingly joined to the preceding add-on module which also results in a total housing.

The housing of the basic configuration is preferably formed by a base frame and a cover which closes off the base frame. The add-on module exhibits a module frame, i.e. is open on two sides. This module frame, together with the base frame, forms a total base frame of the base station in a positively locked manner. In this arrangement, module frame and base frame are firmly but detachably connected to one another via connecting elements. The same applies to the connection of two module frames which are also designed in such a manner that they form a positively locked total frame after being joined together.

Furthermore, the base frame can have an integral bottom, i.e. a permanently arranged cover area. However, it is also possible that the base frame of the base configuration consists of a side frame and a second cover which closes off the second cover area designated as the bottom. In this case, it is possible to arrange the add-on modules on two sides of the basic configuration. The base frame, and thus also the module frame, preferably have a rectangular cross section. Other geometric shapes are possible and depend on the design or the local situations.

In the case where the basic configuration and the add-on modules have housings and these are included in the building block design, it is possible to connect the carriers or racks, respectively, of the individual modules, which carriers or racks exhibit the electrical assemblies, to one another only by means of electrical connectors, for example in the form of corresponding ribbon cables in order to effect the data transport between the assemblies.

The basic configuration and each add-on module preferably have separate temperature control and/or filtering.

Using a basic configuration of a microBTS with minimum volume and moving or transferring additional functions into add-on modules which are added to the basic configuration, the expansion of the basic configuration being taken into consideration during its design, for example by using a corresponding bus system and a suitable data transmission protocol etc., defines a building block system with the aid of which the most varied configurations of a base station can be formed. The result is that (almost) no feature of a macroBTS needs to be excluded and the volume of the microBTS is optimized with the technical options demanded or desired. It is of particular advantage that subsequent features of the microBTS can be added so that a microBTS can be upgraded in future.

In the text which follows, a preferred embodiment of the invention will be explained with reference to the single FIGURE.

The figure diagrammatically shows a basic configuration 1, enclosed by a housing, of a base station and add-on modules 2, 3, 4, 5 and 6 arranged above it. The circle enclosing the basic configuration 1 and the add-on modules 2-6 arranged above it is intended to illustrate that this is a building block system and that further modules can also be added. Depending on if any, and if yes how many, add-on modules are connected to the basic configuration 1, the expanded base stations 7, 8, 9, 10, 11 and 12 are obtained. Thus, for example, base station 7 only comprises the basic configuration 1, whereas the base station consists of basic configuration 1 and one add-on module 2. The configuration of the remaining base stations 8-12 can be seen from the self-explanatory figure. As can also be seen from the diagrammatic drawing, the housings are constructed in such a way that, after the basic configuration 1 has been joined to the corresponding number of add-on modules 2-6 of different functions, a common housing is obtained. This occurs, for example, by the cladding or the housing of a basic configuration consisting of at least two parts, namely a cover 21 and a base frame 20. After the cover 21 has been removed, an add-on module 2-6 or a number of add-on modules 2-6 are mounted. Following this, one or more module frames 22, corresponding to the number of additional add-on modules 2-6, are added to the base frame 20 and the cover 21 is again arranged on the topmost module frame at the top. The terms “top” and “bottom” correspond to the representation in the figure and the base station 7-12 is preferably operated in an upright manner. However, this is not mandatory and the spatial arrangement of the base station depends on how it is used. If, furthermore, the module frames 22 are an integral component of the add-on modules 2-6, the assembly and expansion of a base station is further simplified.

1. A base station of a mobile radio communications system comprising electronic assemblies, characterized in that the base station (7, 8, 9, 10, 11, 12) has a basic configuration (1) of a microBTS with minimum volume and at least one add-on module (2, 3, 4, 5, 6) which is connected to the basic configuration (1),
in that the basic configuration (1) is enclosed by a housing (20, 21) which can be modularly expanded by the housing of the at least one add-on module (2, 3, 4, 5, 6) as a result of which a housing with minimum volume of the base station is formed,
in that the carrying racks of the electronic assemblies of the basic configuration (1) and of the at least one add-on module (2, 3, 4, 5, 6) are formed in such a manner at the connecting areas that they are firmly but detachably connected to one another by connecting elements of a mechanical and electrical nature.

2. The base station as claimed in claim 1, characterized in that the housing of the basic configuration (1) exhibits a base frame (20) which is modularly expandable by a module frame (22) which encloses at least one add-on module (2, 3, 4, 5, 6).

3. The base station as claimed in claim 1 or 2, characterized in that the housing of the basic configuration (1) exhibits a cover which forms the cover of the housing of the base station (7, 8, 9, 10, 11, 12).

4. The base station as claimed in claim 2, characterized in that the base frame (20) and the at least one module frame (22) or two module frames (22) are firmly but detachably connected to one another via connecting elements.

5. The base station as claimed in one of the preceding claims, characterized in that the racks carrying the electronic assemblies of the basic configuration (1) and of the add-on module (2, 3, 4, 5, 6) have an identical cross section and are formed in such a manner at the connecting areas that they are firmly but detachably connected to one another by connecting elements of a mechanical and electrical nature.

6. The base station as claimed in claim 1, characterized in that the racks are connected via a plug-in connection.

7. The base station as claimed in one of the preceding claims, characterized in that the basic configuration (1) and each add-on module (2, 3, 4, 5, 6) exhibit separate temperature control.
